(19) United States
(12) Patent Application Publication
(10) Pub. No.: US 2026/0111456 A1
(43) Pub. Date: Apr. 23, 2026

(54) EMBEDDINGS METADATA PREPROCESSOR FOR DOCUMENT BASES

(71) Applicant: SAP SE, Walldorf (DE)

(72) Inventor: David Kunz, Wilhelmsfeld (DE)

(21) Appl. No.: 18/918,568

(22) Filed: Oct. 17, 2024

(51) Int. Cl. G06F 16/332; G06F 16/33; G06F 16/383

(52) U.S. Cl. CPC G06F 16/3329; G06F 16/3347; G06F 16/383

(57) ABSTRACT

In an example embodiment, semantic chunking is combined with a metadata enrichment mechanism where chunks are enriched with additional metadata prior to being embedded. These embeddings may then be stored in a vector database and used to perform enriched similarity searches for augmentation of context provided to an LLM during LLM generation requests.

### TECHNICAL FIELD

This document generally relates to computer systems. More specifically, this document relates to use of large language models used in computer systems.

### BACKGROUND

A large language model (LLM) refers to an artificial intelligence (AI) model that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for automatically enriching a chunk of a document for embedding, in accordance with an example embodiment.

FIG. 2 is a flow diagram illustrating a method for automatically enriching a chunk of a document for embedding, in accordance with an example embodiment.

FIG. 3 is a block diagram illustrating an architecture of software.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

One of the biggest technical challenges involved in using LLMs for code generation is providing the correct context. LLMs operate better when they are not just provided with bare requests for generation (e.g., “generate me some code to do X”) but are also provided with some contextual information, such as the location of the code in which the newly generated code is to be placed, related files with important definitions, etc. The more context the LLM has for a request, the better the reliability of code generation will be. If one were to hypothetically provide every code snippet in an entire application's worth of code to the LLM, then the resultant code generated would be very reliable.

The problem is that LLMs typically have a limit on how much context is able to be provided with a request (e.g., a maximum number of input tokens), and even in cases where such limits do not exist or where the limits are not quite reached, adding additional context adds to inference costs (either in money or in speed, for example). Thus, while it is important to provide relevant context for a request to an LLM, it is also important not to provide irrelevant context. Identifying relevant context, however, can be technically challenging.

One approach to handling this technical issue is to use Retrieval Augmented Generation (RAG). RAG is a framework that combines traditional retrieval techniques with generative models to improve the quality of generated responses, particularly in tasks like question answering or conversational agents.

In RAG, the process typically involves two main steps:
Retrieval: The system first retrieves relevant documents or pieces of information from a large database or knowledge base based on the input query. This can be performed using techniques like search algorithms or vector embeddings to find the most pertinent information.
Generation: After retrieving relevant information, a generative model (like an LLM) processes this data to produce a coherent and contextually appropriate response. The model can leverage the retrieved content to enhance its answers, making them more accurate and informative.

The combination allows the model to provide richer, more context- aware responses than it could generate from scratch, tapping into a larger body of knowledge while still being able to generate natural language. RAG is particularly useful in scenarios where real-time access to up-to-date information is critical.

In the case of vector embeddings, a vector embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector, and the texts with similar semantics will have the corresponding similar embeddings.

Thus, in one example embodiment, vector embeddings may be combined with RAG to provide improved LLM generation. Specifically, an embedding machine learning model is trained on a large corpus of text and then used to perform the embedding of the underlying text into embeddings. This allows similar pieces of text to be identified even from text that is different. For example, text including the term “apartment” may be similar to text including the term “flat”, even though their words are completely different. Thus, the embeddings for these two words may be geometrically close to each other in the latent n-dimensional space.

A technical issue arises, however, when embedding large documents. Embedding the entire large document as a whole is virtually worthless because the embedding becomes so specific to the document as a whole that it is nearly impossible to identify similar embeddings to it, and even if a similar document were found it would not be that helpful because it would not be clear which parts of the documents were similar.

One could, however, split the document into multiple chunks and embed each chunk separately. For example, if the document is ten pages long, the document could be split into ten chunks, each being a page long. While this makes identifying text similar to a particular page of a document more accurate when just taking the view of the particular page, there is some information loss when these techniques are applied to chunks in this manner. Specifically, while intra-chunk context (e.g., contextual relationships between words or concepts within a single page) is captured using this technique, inter-chunk context (e.g., contextual relationships between words or concepts between two pages) is not captured. Thus, if how the document is chunked is not performed with care, the reliability of the text generated based on embeddings of the chunks, even when using RAG, will suffer.

Indeed, this problem is exacerbated when chunks are even smaller, such as being one sentence per chunk. There is even more information loss as the chunks get smaller and smaller. As common as it is for text on one page of a document to be related to another page of the document, it is even more common for text in one sentence of a paragraph to be related to the next sentence in that paragraph.

In an example embodiment, semantic chunking is performed, where chunking of an input document is performed on a section-basis, specifically that each chunk represents a different section of the document. Care still has to be taken, however, in that sections can sometimes themselves be somewhat large, which not only makes them less useful but in the case of RAG where the large sections are found in the vector database, those large sections will be provided as input to the LLM, which may exceed the token limit of the LLM.

In an example embodiment, semantic chunking is combined with a metadata enrichment mechanism where chunks are enriched with additional metadata prior to being embedded. These embeddings may then be stored in a vector database and used to perform enriched similarity searches for augmentation of context provided to an LLM during LLM generation requests.

In a further example embodiment, the semantic chunking is combined categorization system where how a document is chunked is based at least in part on categories assigned to subsets of the document. These subsets are different than the chunks. This categorization may be performed by feeding the subsets themselves to the LLM prior to chunking to generate categories of the text of each subset. These categories for all of the subsets are then sent to the LLM to be merged into a single list of categories for the entire document. Each subset is then tagged with the corresponding LLM-generated categories. Then, the LLM is used again to determine how to semantically chunk the document into semantically meaningful sections, and also to create links, in the form of metadata, between chunks that are related to each other. This metadata adds additional context to each chunk, which can be used later in the process.

For each chunk, the LLM can then be used to assign tags to the chunk based on the categories in the single list of categories. These tags also represent metadata. Furthermore, the metadata can be enriched by passing the chunks and metadata along with document-specific questions to the LLM, resulting in document-specific answers to the questions, and the answer to these questions can be added as additional metadata to the chunks.

Additionally, the metadata can then be send with its corresponding chunk to the LLM when embedding the chunks. Essentially, the embedding has been enriched by the metadata, which can include links, tags, and document-specific answers, resulting in a fully enriched vector database for similarity searches.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The present solution works with any type of GAI model, although an implementation that specifically is used with a GPT model will be described.

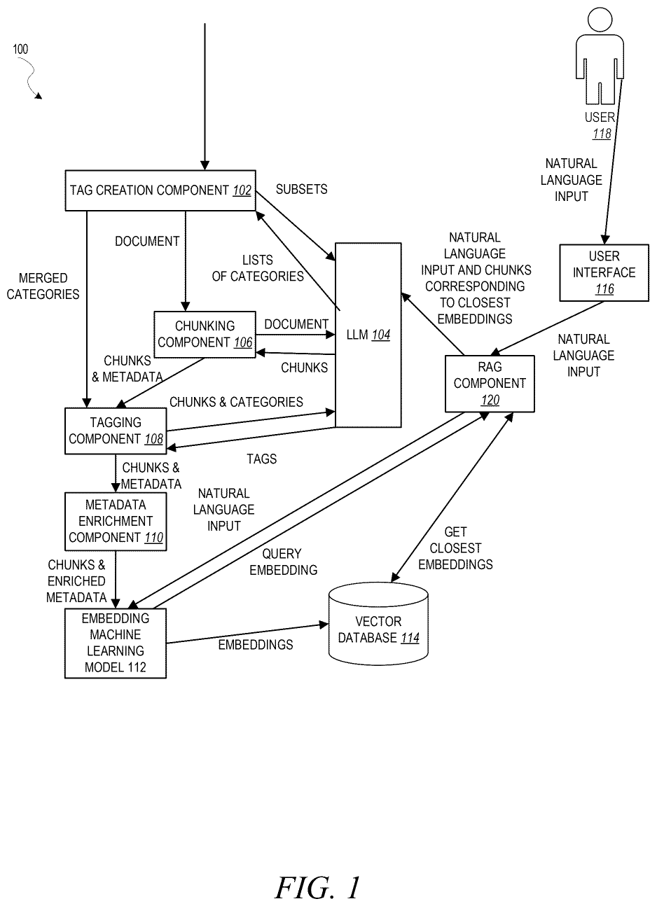

FIG. 1 is a block diagram illustrating a system 100 for automatically enriching a chunk of a document for embedding, in accordance with an example embodiment. Here a tag creation component 102 receives a document. The tag creation component 102 splits this document into a plurality of subsets. This may be performed in a number of different ways. In an example embodiment, the subsets are substantially equally divided portions of the document, for example each subset may be a different page of the document, or a different group of pages. There is no necessity, however, that these subsets be equal or even substantially equal in size. Preferably, each subset is at least small enough to be below the token limit of the LLM 104, but other than that, the subsets can be of any size. Each subset is then passed individually to the LLM 104 with a prompt requesting that the LLM 104 generate one or more categories for the corresponding subset. Thus, each subset would have its own generated set of categories. Then the generated set of categories for all of the subsets are then sent together to the LLM 104 with a prompt requesting that the LLM 104 merge the categories, producing a merged set of categories.

A chunking component 106 generates a prompt to the LLM 104 to semantically chunk the document into appropriate chunks, without losing too much context, while also generating links between related chunks. The LLM 104 therefore then produces a series of chunks of the document, with each chunk potentially including links as metadata (here the chunks are each depicted as having metadata but in reality, it is not necessary that each chunk have generated metadata at this stage).

A tagging component 108 then takes each chunk (and corresponding metadata, if any) and sends to the LLM 104 with the merged set of categories and with a prompt requesting that the LLM 104 assign one or more categories, as metadata (in the form of tags), to each chunk as appropriate.

A metadata enrichment component 110 then takes each chunk, including its metadata (which at this point may include link(s) and/or category(ies), and send it to the LLM 104 with a list of one or more document-specific questions, with a prompt requesting that the LLM 104 generate document-specific answers to the document-specific questions, based on the chunks and metadata. This results in document-specific answers, which are then added to the metadata of the chunks by the metadata enrichment component 110.

It should be noted that while the LLM 104 has been described as performing the many different tasks described above, in some example embodiments these tasks do not necessarily have to be performed by a single LLM 104. Multiple LLMs may be used instead of one LLM 104.

Each chunk, along with its metadata (which at this point may includelink(s) and/or category(ies) and/or document-specific answers) is fed through an embedding machine learning model 112 that embeds this information into a different embedding for each chunk/metadata and stores the embeddings in a vector database 114.

The embedding machine learning model 112 may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the embedding machine learning algorithm used to train the embedding machine learning model 112 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the embedding machine learning model 112 may take place as a dedicated training phase. In other example embodiments, the embedding machine learning model may be retrained dynamically at runtime based on feedback.

In an example embodiment, the embedding machine learning model is part of the LLM 104, or at least of some LLM. LLMs provide for natural language processing (NPL) of text and rely on embeddings as part of its processing.

When a GAI model generates new, original data, it goes through the process of evaluating and classifying the data input to it. The product of this evaluation and classification is utilized to generate embeddings for data, which can then be later used to actually generate new data by the GAI model. In an example embodiment, however, the new, original data is either not generated or is irrelevant to the present solution. Rather, an embedding for the input piece of text is generated based on the intermediate work product of the GAI model that it would produce when going through the motions of generating the new, original data.

The result of an embedding process performed on a piece of data is an embedding, which is a vector. The vector may then be stored in a vector database 114.

A user interface 116 is provided to interact with a user 118, allowing the user 118 to make requests for the LLM 104 to perform a generative task (such as generating new text) based on, for example, a natural language input. The user interface 116 then interacts with a RAG component 120 that passes the natural language input to the embedding machine learning model 112 to obtain a query embedding, and then performs a similarity search on the vector database 114 to identify one or more chunks that are similar to the natural language input. This may be performed by finding embeddings, in the vector database 114, that are geometrically closest to the query embedding. In an example embodiment, this may be performed by calculating the cosine correlation coefficient between the embedding vs and the embeddings vr of every chunk by the following formula.

$${c}_{s , r} = \frac{{\sum }_{n = 1}^{N} ( {v}_{s , n} \cdot {v}_{r , n} )}{\sqrt{{\sum }_{n = 1}^{N} {( {v}_{s , n} )}^{2}} \cdot \sqrt{{\sum }_{n = 1}^{N} {( {v}_{r , n} )}^{2}}}$$

Where N is the dimension of the embeddings, v_{s,n} is the n-th element vₛ, and v_{r,n} is the n-th element of vᵣ.

What counts as “similar” may be defined based on a preset threshold Cₜₕ, and thus record IDs whose c_{s,r} are greater than a threshold Cₜₕ are selected as “similar” embeddings. Then the results corresponding to the similar embeddings, may be retrieved and returned.

Any similar embeddings can then be added as context to a prompt to the LLM 104 to generate text based on the natural language query.

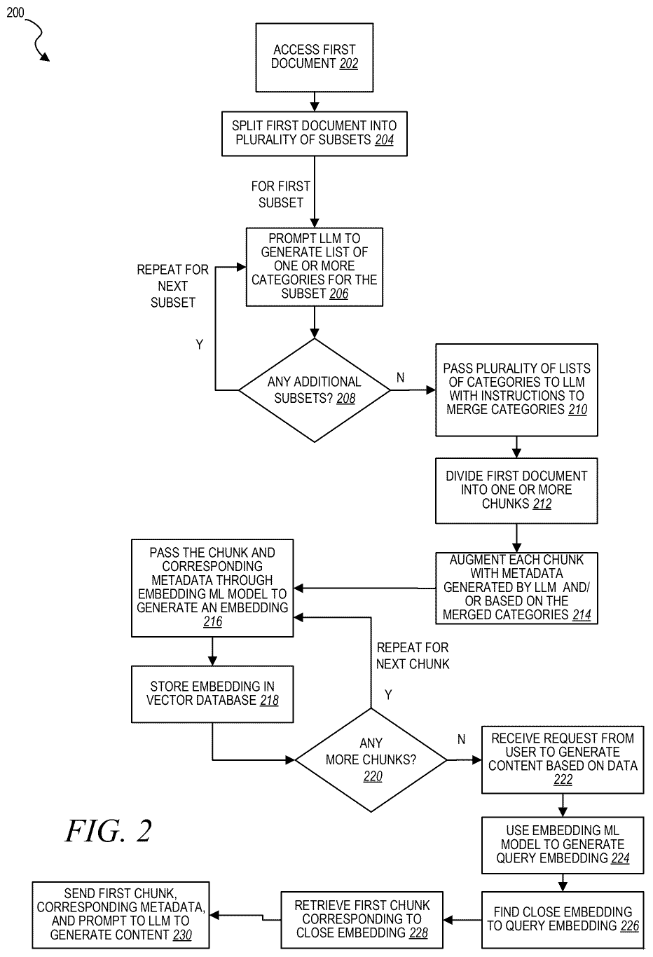

FIG. 2 is a flow diagram illustrating a method 200 for using an LLM to generate content, in accordance with an example embodiment. At operation 202, a first document is accessed. In some example embodiments, at operation 204, the first document is split into a plurality of subsets. A loop is then begun for each subset in the plurality of subsets. At operation 206, the LLM is prompted to generate a list of one or more categories for the subset. At operation 208, it is determined if there are any additional subsets. If so, the method 200 loops back to operation 206 for the next subset. If not, then at operation 210 a plurality of lists of one or more categories generated by the LLM are passed to the LLM with a request to merge categories in the plurality of lists of one or more categories into a merged list of one or more categories.

At operation 212, the first document is divided into one or more chunks. In some example embodiments, the dividing comprises passing the first document to the LLM with a prompt requesting the LLM to divide the first document into semantically meaningful chunks and to generate links among related chunks, and wherein the augmenting further comprises adding the links as corresponding metadata to corresponding chunks.

At operation 214, each of the one or more chunks is augmented with metadata generated by an LLM. If the merged list of categories was created at operations 206-208, then this augmenting further comprises adding one or more categories from the merged list of one or more categories to each chunk. In some additional example embodiments, the augmenting further comprises passing the chunks along with first document-specific questions to the LLM with a prompt requesting that the LLM generate first document-specific answers to the first document-specific questions, and adding the first document-specific questions as corresponding metadata to the chunks.

Then a loop is begun for each chunk of the one or more chunks. At operation 216, the chunk and corresponding metadata are passed through an embedding machine learning model to generate an embedding. At operation 218, the embedding is stored in a vector database. At operation 220, it is determined if there are any more chunks. If so, then the method 200 loops back to operation 216 for the next chunk. If not, then the method 200 moves to operation 222, where a request from a user to generate content based on data is received.

At operation 224, the data is passed through the embedding machine learning model to generate a query embedding. At operation 226, a close embedding geometrically close to the query embedding is found, in the vector database. At operation 228, a first chunk corresponding to the close embedding is retrieved. The first chunk has first corresponding metadata. At operation 230, the data, the first chunk, the first corresponding metadata, and a prompt instructing the LLM to generate the content based on the data, the first chunk, and the first corresponding metadata, are all sent to the LLM, causing the generation of the content.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: accessing a first document; dividing the first document into one or more chunks; augmenting each of the one or more chunks with metadata generated by a Large Language Model (LLM) for each chunk of the one or more chunks: passing the chunk and corresponding metadata through an embedding machine learning model to generate an embedding, the embedding being a vector of coordinates in a latent n-dimensional space; and storing the embedding in a vector database; receiving a request from a user to generate content based on data; passing the data through the embedding machine learning model to generate a query embedding; finding a close embedding geometrically close to the query embedding, in the vector database; retrieving a first chunk corresponding to the close embedding, the first chunk having first corresponding metadata; and submitting, to the LLM, the data, the first chunk, the first corresponding metadata, and a prompt instructing the LLM to generate the content based on the data, the first chunk, and the first corresponding metadata.

In Example 2, the subject matter of Example 1 comprises, wherein the operations further comprise: splitting the first document into a plurality of subsets; for each subset in the plurality of subsets: prompting the LLM to generate a list of one or more categories for the subset; passing a plurality of lists of one or more categories generated by the LLM to the LLM with a request to merge categories in the plurality of lists of one or more categories into a merged list of one or more categories; and wherein the augmenting comprises adding one or more categories from the merged list of one or more categories to each chunk.

In Example 3, the subject matter of Example 2 comprises, wherein the augmenting further comprises passing the merged list of one or more categories along with each chunk to the LLM with a prompt requesting the LLM assign one or more categories from the merged list of one or more categories to each chunk.

In Example 4, the subject matter of Examples 1-3 comprises, wherein the dividing comprises passing the first document to the LLM with a prompt requesting the LLM to divide the first document into semantically meaningful chunks and to generate links among related chunks, and wherein the augmenting further comprises adding the links as corresponding metadata to corresponding chunks.

In Example 5, the subject matter of Examples 1-4 comprises, wherein the augmenting further comprises passing the chunks along with first document-specific questions to the LLM with a prompt requesting that the LLM generate first document-specific answers to the first document-specific questions, and adding the first document-specific questions as corresponding metadata to the chunks.

In Example 6, the subject matter of Examples 1-5 comprises, wherein the embedding machine learning model is part of the LLM.

In Example 7, the subject matter of Examples 1-6 comprises, wherein the data is natural language text.

Example 8 is a method comprising: accessing a first document; dividing the first document into one or more chunks; augmenting each of the one or more chunks with metadata generated by a Large Language Model (LLM) for each chunk of the one or more chunks: passing the chunk and corresponding metadata through an embedding machine learning model to generate an embedding, the embedding being a vector of coordinates in a latent n-dimensional space; and storing the embedding in a vector database; receiving a request from a user to generate content based on data; passing the data through the embedding machine learning model to generate a query embedding; finding a close embedding geometrically close to the query embedding, in the vector database; retrieving a first chunk corresponding to the close embedding, the first chunk having first corresponding metadata; and submitting, to the LLM, the data, the first chunk, the first corresponding metadata, and a prompt instructing the LLM to generate the content based on the data, the first chunk, and the first corresponding metadata.

In Example 9, the subject matter of Example 8 comprises, splitting the first document into a plurality of subsets; for each subset in the plurality of subsets: prompting the LLM to generate a list of one or more categories for the subset; passing a plurality of lists of one or more categories generated by the LLM to the LLM with a request to merge categories in the plurality of lists of one or more categories into a merged list of one or more categories; and wherein the augmenting comprises adding one or more categories from the merged list of one or more categories to each chunk.

In Example 10, the subject matter of Example 9 comprises, wherein the augmenting further comprises passing the merged list of one or more categories along with each chunk to the LLM with a prompt requesting the LLM assign one or more categories from the merged list of one or more categories to each chunk.

In Example 11, the subject matter of Examples 8-10 comprises, wherein the dividing comprises passing the first document to the LLM with a prompt requesting the LLM to divide the first document into semantically meaningful chunks and to generate links among related chunks, and wherein the augmenting further comprises adding the links as corresponding metadata to corresponding chunks.

In Example 12, the subject matter of Examples 8-11 comprises, wherein the augmenting further comprises passing the chunks along with first document-specific questions to the LLM with a prompt requesting that the LLM generate first document-specific answers to the first document-specific questions, and adding the first document-specific questions as corresponding metadata to the chunks.

In Example 13, the subject matter of Examples 8-12 comprises, wherein the embedding machine learning model is part of the LLM.

In Example 14, the subject matter of Examples 8-13 comprises, wherein the data is natural language text.

Example 15 is a non-transitory machine-readable medium storing instructions which, when executed by one or more processors, cause the one or more processors to perform operations comprising: accessing a first document; dividing the first document into one or more chunks; augmenting each of the one or more chunks with metadata generated by a Large Language Model (LLM); for each chunk of the one or more chunks: passing the chunk and corresponding metadata through an embedding machine learning model to generate an embedding, the embedding being a vector of coordinates in a latent n-dimensional space; and storing the embedding in a vector database; receiving a request from a user to generate content based on data; passing the data through the embedding machine learning model to generate a query embedding; finding a close embedding geometrically close to the query embedding, in the vector database; retrieving a first chunk corresponding to the close embedding, the first chunk having first corresponding metadata; and submitting, to the LLM, the data, the first chunk, the first corresponding metadata, and a prompt instructing the LLM to generate the content based on the data, the first chunk, and the first corresponding metadata.

In Example 16, the subject matter of Example 15 comprises, wherein the operations further comprise: splitting the first document into a plurality of subsets; for each subset in the plurality of subsets: prompting the LLM to generate a list of one or more categories for the subset; passing a plurality of lists of one or more categories generated by the LLM to the LLM with a request to merge categories in the plurality of lists of one or more categories into a merged list of one or more categories; and wherein the augmenting comprises adding one or more categories from the merged list of one or more categories to each chunk.

In Example 17, the subject matter of Example 16 comprises, wherein the augmenting further comprises passing the merged list of one or more categories along with each chunk to the LLM with a prompt requesting the LLM assign one or more categories from the merged list of one or more categories to each chunk.

In Example 18, the subject matter of Examples 15-17 comprises, wherein the dividing comprises passing the first document to the LLM with a prompt requesting the LLM to divide the first document into semantically meaningful chunks and to generate links among related chunks, and wherein the augmenting further comprises adding the links as corresponding metadata to corresponding chunks.

In Example 19, the subject matter of Examples 15-18 comprises, wherein the augmenting further comprises passing the chunks along with first document-specific questions to the LLM with a prompt requesting that the LLM generate first document-specific answers to the first document-specific questions, and adding the first document-specific questions as corresponding metadata to the chunks.

In Example 20, the subject matter of Examples 15-19 comprises, wherein the embedding machine learning model is part of the LLM.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

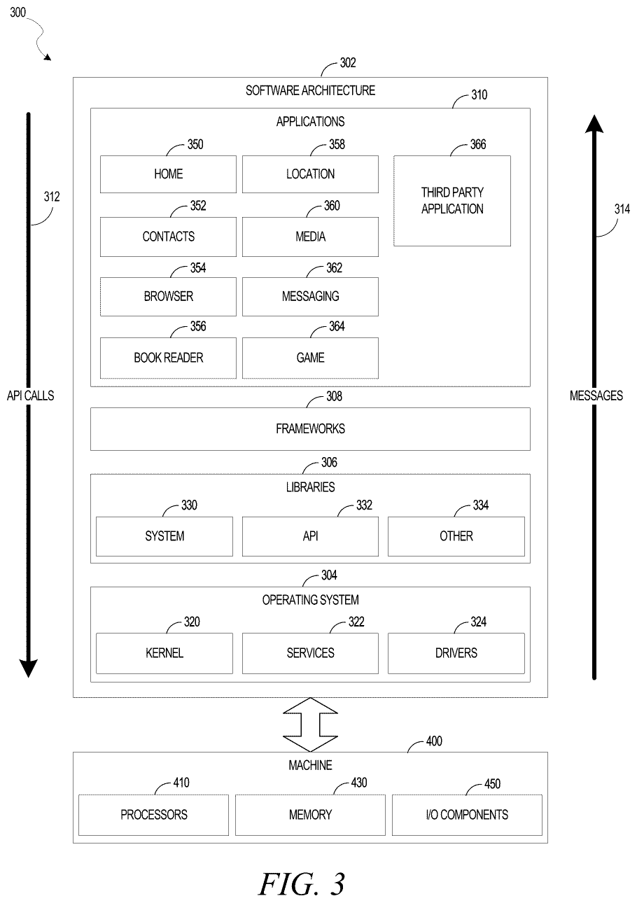

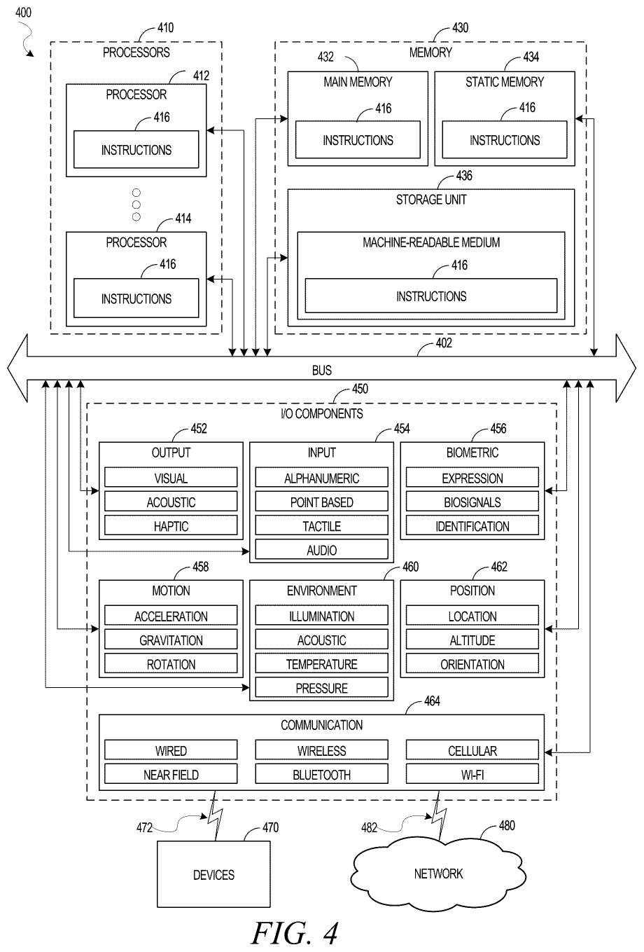

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that includes processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionalities. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low-Energy drivers, flash memory drivers, serial communication drivers (c.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various GUI functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. According to some embodiments, the applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 to facilitate functionality described herein.

FIG. 4 illustrates a diagrammatic representation of a machine 400 in the form of a computer system within which a set of instructions may be executed for causing the machine 400 to perform any one or more of the methodologies discussed herein, according to an example embodiment. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the method 200 of FIG. 2. Additionally, or alternatively, the instructions 416 may implement FIGS. 1-2 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within the main memory 432, within the static memory 434, within the storage unit 436, within at least one of the processors 410 (e.g., within the processor's cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (e.g., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., crasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., HTTP). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
accessing a first document;
dividing the first document into one or more chunks;
augmenting each of the one or more chunks with metadata generated by a Large Language Model (LLM);
for each chunk of the one or more chunks:
passing the chunk and corresponding metadata through an embedding machine learning model to generate an embedding, the embedding being a vector of coordinates in a latent n-dimensional space; and
storing the embedding in a vector database;
receiving a request from a user to generate content based on data;
passing the data through the embedding machine learning model to generate a query embedding;
finding a close embedding geometrically close to the query embedding, in the vector database;
retrieving a first chunk corresponding to the close embedding, the first chunk having first corresponding metadata; and
submitting, to the LLM, the data, the first chunk, the first corresponding metadata, and a prompt instructing the LLM to generate the content based on the data, the first chunk, and the first corresponding metadata.

2. The system of claim 1, wherein the operations further comprise:
splitting the first document into a plurality of subsets;
for each subset in the plurality of subsets:
prompting the LLM to generate a list of one or more categories for the subset;
passing a plurality of lists of one or more categories generated by the LLM to the LLM with a request to merge categories in the plurality of lists of one or more categories into a merged list of one or more categories; and
wherein the augmenting comprises adding one or more categories from the merged list of one or more categories to one or more chunks.

3. The system of claim 2, wherein the augmenting further comprises passing the merged list of one or more categories along with each chunk to the LLM with a prompt requesting the LLM assign one or more categories from the merged list of one or more categories to each chunk.

4. The system of claim 1, wherein the dividing comprises passing the first document to the LLM with a prompt requesting the LLM to divide the first document into semantically meaningful chunks and to generate links among related chunks, and wherein the augmenting further comprises adding the links as corresponding metadata to corresponding chunks.

5. The system of claim 1, wherein the augmenting further comprises passing the chunks along with first document-specific questions to the LLM with a prompt requesting that the LLM generate first document-specific answers to the first document-specific questions, and adding the first document-specific questions as corresponding metadata to the chunks.

6. The system of claim 1, wherein the embedding machine learning model is part of the LLM.

7. The system of claim 1, wherein the data is natural language text.

8. A method comprising:
accessing a first document;
dividing the first document into one or more chunks;
augmenting each of the one or more chunks with metadata generated by a Large Language Model (LLM);
for each chunk of the one or more chunks:
passing the chunk and corresponding metadata through an embedding machine learning model to generate an embedding, the embedding being a vector of coordinates in a latent n-dimensional space; and
storing the embedding in a vector database;
receiving a request from a user to generate content based on data;
passing the data through the embedding machine learning model to generate a query embedding;
finding a close embedding geometrically close to the query embedding, in the vector database;
retrieving a first chunk corresponding to the close embedding, the first chunk having first corresponding metadata; and
submitting, to the LLM, the data, the first chunk, the first corresponding metadata, and a prompt instructing the LLM to generate the content based on the data, the first chunk, and the first corresponding metadata.

9. The method of claim 8, further comprising:
splitting the first document into a plurality of subsets;
for each subset in the plurality of subsets:
prompting the LLM to generate a list of one or more categories for the subset;
passing a plurality of lists of one or more categories generated by the LLM to the LLM with a request to merge categories in the plurality of lists of one or more categories into a merged list of one or more categories; and
wherein the augmenting comprises adding one or more categories from the merged list of one or more categories to one or more chunks.

10. The method of claim 9, wherein the augmenting further comprises passing the merged list of one or more categories along with each chunk to the LLM with a prompt requesting the LLM assign one or more categories from the merged list of one or more categories to each chunk.

11. The method of claim 8, wherein the dividing comprises passing the first document to the LLM with a prompt requesting the LLM to divide the first document into semantically meaningful chunks and to generate links among related chunks, and wherein the augmenting further comprises adding the links as corresponding metadata to corresponding chunks.

12. The method of claim 8, wherein the augmenting further comprises passing the chunks along with first document-specific questions to the LLM with a prompt requesting that the LLM generate first document-specific answers to the first document-specific questions, and adding the first document-specific questions as corresponding metadata to the chunks.

13. The method of claim 8, wherein the embedding machine learning model is part of the LLM.

14. The method of claim 8, wherein the data is natural language text.

15. A non-transitory machine-readable medium storing instructions which, when executed by one or more processors, cause the one or more processors to perform operations comprising:
accessing a first document;
dividing the first document into one or more chunks;
augmenting each of the one or more chunks with metadata generated by a Large Language Model (LLM);
for each chunk of the one or more chunks:
passing the chunk and corresponding metadata through an embedding machine learning model to generate an embedding, the embedding being a vector of coordinates in a latent n-dimensional space; and
storing the embedding in a vector database;
receiving a request from a user to generate content based on data;
passing the data through the embedding machine learning model to generate a query embedding;
finding a close embedding geometrically close to the query embedding, in the vector database;
retrieving a first chunk corresponding to the close embedding, the first chunk having first corresponding metadata; and
submitting, to the LLM, the data, the first chunk, the first corresponding metadata, and a prompt instructing the LLM to generate the content based on the data, the first chunk, and the first corresponding metadata.

16. The non-transitory machine-readable medium of claim 15, wherein the operations further comprise:
splitting the first document into a plurality of subsets;
for each subset in the plurality of subsets:
prompting the LLM to generate a list of one or more categories for the subset;
passing a plurality of lists of one or more categories generated by the LLM to the LLM with a request to merge categories in the plurality of lists of one or more categories into a merged list of one or more categories; and
wherein the augmenting comprises adding one or more categories from the merged list of one or more categories to one or more chunks.

17. The non-transitory machine-readable medium of claim 16, wherein the augmenting further comprises passing the merged list of one or more categories along with each chunk to the LLM with a prompt requesting the LLM assign one or more categories from the merged list of one or more categories to each chunk.

18. The non-transitory machine-readable medium of claim 15, wherein the dividing comprises passing the first document to the LLM with a prompt requesting the LLM to divide the first document into semantically meaningful chunks and to generate links among related chunks, and wherein the augmenting further comprises adding the links as corresponding metadata to corresponding chunks.

19. The non-transitory machine-readable medium of claim 15, wherein the augmenting further comprises passing the chunks along with first document-specific questions to the LLM with a prompt requesting that the LLM generate first document-specific answers to the first document-specific questions, and adding the first document-specific questions as corresponding metadata to the chunks.

20. The non-transitory machine-readable medium of claim 15, wherein the embedding machine learning model is part of the LLM.
